(19) United States
(12) Patent Application Publication
(10) Pub. No.: US 2010/0061689 A1
(43) Pub. Date: Mar. 11, 2010

(54) Process for Fabricating Buried Optical Waveguides Using Laser Ablation

(75) Inventors: Raman Kashyap, Baie D'Urfe (CA); Vincent Treanton, Cremieu (FR)

Correspondence Address: FAY KAPLUN & MARCIN, LLP, 150 BROADWAY, SUITE 702, NEW YORK, NY, 10038, US

(73) Assignee: CORPORATION DE L'ÉCOLE POLYTECHNIQUE DE MONTRÉAL, Montreal (CA)

(21) Appl. No.: 12/514,743

(22) PCT Filed: Nov. 13, 2007
(86) PCT No.: PCT/CA07/02041

§ 371 Date: Sep. 29, 2009

Related U.S. Application Data
(60) Provisional application No. 60/858,343, filed on Nov. 13, 2006.
(60) Provisional application No. 60/924,924, filed on Jun. 5, 2007.

(51) Int. Cl. G02B 6/10; B29D 11/00

(52) U.S. Cl. 385/131; 264/1.27

(57) ABSTRACT

The present invention is concerned with a process for fabricating a buried optical waveguide, comprising providing a multi-layer piece of material having a waveguide core layer, generating a laser beam and producing by ablation at least two trenches by applying the laser beam onto the multi-layer piece of material. The two trenches extend through the multi-layer piece of material including the core layer. Upon the ablation, melted material from the multi-layer piece is produced and the core layer is encapsulated between the two trenches with the melted material to produce the buried optical waveguide in the multi-layer piece of material. The present invention also relates to a buried optical waveguide comprising a multi-layer piece of material having a waveguide core layer, at least two trenches laser ablated through the multi-layer piece of material including the core layer and encapsulating material having melted from the multi-layer piece upon laser ablation and leaked to cover and therefore encapsulate the core layer in the at least two trenches to thereby form the buried optical waveguide.

### FIELD OF THE INVENTION

The present invention generally relates to a process for fabricating optical waveguides. More specifically, but not exclusively, the present invention is concerned with a process for fabricating optical planar ridge waveguides using a laser beam, wherein the waveguide is buried within the ridge.

### BACKGROUND OF THE INVENTION

For many years, the photonics industry has grown steadily, primarily driven by the increasing demand for complex optical functionalities. More recently, the need to save space and the need for lower cost of deployment have overtaken the requirements for developing optical devices. Many promising techniques have been proposed to create an all-optical network using novel passive and active optical devices to modify the transmitted information, for example in the telecommunication field. However, many of these techniques and devices failed to meet the expectations on grounds of cost.

Until recently, devices were based on fibre or free space, both of which require careful alignment and subcomponent selection, resulting in low yields and expensive products caused mainly by the remaining intensive labour. More recently, planar optical integrated circuits were introduced with the following potential advantages: possibility of manufacturing in existing microelectronics facilities, integrating sources and detectors with other devices on the same chip, and minimizing alignment requirements which lead to better reproducibility. All these advantages make the technique more suitable for mass production thus potentially reducing costs. Even though there is currently considerable interest in the potential of this technology, it produces devices with moderate insertion loss due to the fabrication processes as well as the input/output coupling. Another drawback of current planar optical manufacturing processes is that they require expensive facilities to perform the micro-fabrication and place considerable restrictions on the types of materials that can be used as substrates.

Current planar optical waveguide manufacturing processes include direct writing of the waveguide by an ultraviolet laser. However, this technique is limited to writing in materials which are highly photosensitive, and therefore cannot be applied to most optically non-linear materials.

It has also been proposed to use a femto-second laser that generates ultra-short laser pulses. Even though this technique can be used for writing into many types of materials, a drawback is that this technique induces modification in the material structure. This yields asymmetry and irregularities in the resulting waveguide, thereby increasing the losses in the cross coupling with optical fibres for example, and also a modification of the material properties in the region of interest. Moreover, this technique causes damage to the material by yielding a depression at the irradiation site, which may be detrimental to subsequent layer deposition. Furthermore, the writing speed is very slow and the index difference that can be induced is intrinsically linked to loss; therefore, commercial exploitation of this technique is limited.

Plasma enhanced chemical vapour deposition (PECVD) also finds application in the fabrication of optical waveguides. However, a drawback of PECVD is that it is intensive in processing and requires a large infrastructure and many processing steps to fabricate the waveguides. For example, mask-making, alignment techniques, chemical or plasma ablation, and re-flow to cover the waveguides are required for successful fabrication of waveguides using PECVD.

Also, surface quality of ablated regions of an optical waveguide has a significant impact on propagation loss therein and determines whether a waveguide will properly guide light. More specifically, it is desirable that the surface of an ablated region be as smooth as possible and results from a uniform ablation, exempt of cracking or of showing a wavy surface. The quality of a surface resulting from an ablation may be evaluated by using a scanning electron microscope (SEM), in combination with a polymer template.

Moreover, the higher is the wall roughness of trenches of an optical waveguide, the higher will be the propagation loss. For example, using a femto-second laser for fabricating an optical waveguide by simple ablation creates a sawing action that can generate roughness of the walls of the trenches, which increases the propagation loss. When an infrared light beam propagates at a wavelength of 1550 nm in such a waveguide, the light beam impacts the walls of the trenches and scattering occurs, inducing in turn losses in the optical waveguide.

Accordingly, an economical method for performing ablations resulting in ridge waveguides having smooth surfaces, using only one readily available laser beam would find wide application in the photonics industry. Moreover, a waveguide completely buried into a medium having a lower refractive index would allow for reduction of the propagation loss.

### SUMMARY OF THE INVENTION

More specifically, according to the present invention, there is provided a process for fabricating a buried optical waveguide, comprising: providing a multi-layer piece of material having a waveguide core layer; generating a laser beam; producing by ablation at least two trenches by applying the laser beam onto the multi-layer piece of material, the at least two trenches extending through the multi-layer piece of material including the core layer; and upon the ablation, producing melted material from the multi-layer piece and encapsulating the core layer between the at least two trenches with the melted material to produce the buried optical waveguide in the multi-layer piece of material.

The present invention is also concerned with a buried optical waveguide comprising: a multi-layer piece of material having a waveguide core layer; at least two trenches laser ablated through the multi-layer piece of material including the core layer; and encapsulating material having melted from the multi-layer piece upon laser ablation and leaked to cover and therefore encapsulate the core layer in the at least two trenches to thereby form the buried optical waveguide.

The foregoing and other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a schematic view illustrating an optical assembly, comprising a CO₂ laser beam for fabricating an optical waveguide, according to one non-restrictive, illustrative embodiment of the present invention;

FIG. 2 is a cross sectional view of a planar, multi-layer piece of material before ablation;

FIG. 3 is a cross sectional view of the planar, multi-layer piece of material of FIG. 2 after it has been processed in accordance with one non-restrictive, illustrative embodiment of the present invention;

FIG. 4 is a schematic view showing a laser beam splitter, which is commercially available, for creating two laser beams from a single input laser beam by reflecting a first half of the input laser beam and transmitting the second half thereof, thus generating two identical laser beams each with about half of the initial laser power;

FIG. 5 is a photograph showing a smooth ridge optical waveguide fabricated using a process according to one non-restrictive illustrative embodiment of the present invention, and a magnified portion of this smooth ridge optical waveguide;

FIG. 6a is a photograph of a section of a trench produced using the above-mentioned process according to one non-restrictive illustrative embodiment of the present invention, the trench having a typical depth of 12 μm;

FIG. 6b is a photograph of a top view of a trench produced using the above-mentioned process according to one non-restrictive illustrative embodiment of the present invention, the trench having a typical width of 12 μm and a typical roughness lower than 10 nm;

FIG. 7a is a photograph of a top view of a optical ridge waveguide produced using the above-mentioned process according to one non-restrictive illustrative embodiment of the present invention, the ridge waveguide being connected to an optical fiber;

FIG. 7b is a near field mode profile of a propagation mode guided in the optical ridge waveguide of FIG. 7a, as measured by an infrared beam profiler system which allows real-time measurement of the spatial distribution of an incident laser beam;

FIG. 8 is a graph showing the insertion loss as a function of wavelength, for an optical ridge waveguide produced using the above-mentioned process according to one non-restrictive illustrative embodiment of the present invention, coupled to an optical fiber;

FIG. 9 is a graph showing the propagation loss as a function of wavelength, for an optical ridge waveguide produced using the above-mentioned process according to one non-restrictive illustrative embodiment of the present invention;

FIG. 10 is a cross sectional view of the planar, multi-layer piece of material of FIG. 2, after it has undergone a standard ablation;

FIG. 11 is a photograph of an optical waveguide produced using the above-mentioned process according to one non-restrictive illustrative embodiment of the present invention, wherein the optical waveguide is illuminated from the rear with white light;

FIG. 12 is a schematic diagram showing the basic principle of operation of a MMI (Multi-Mode Interference) structure;

FIG. 13 is a plan view of an optical device fabricated using a process according to another non-restrictive illustrative embodiment of the present invention, showing an exciting mode and a split output; and

FIG. 14 is a display illustrative of a simulation of a 1×2 splitter fabricated using the process according to FIG. 13, in a planar silica sample using a laser ablation technique; and

FIG. 15 is a display showing a simulation of a compact 1×2 splitter, in which only a small section of a planar waveguide is needed.

### DETAILED DESCRIPTION

In the present specification, the terms “optical” and “light” are intended to designate visible and invisible electromagnetic radiations capable of being propagated through an optical waveguide as described in the present specification. In the same manner, in the present specification, the term “optical waveguide” is intended to designate a waveguide capable of propagating visible and invisible electromagnetic radiations.

The non-restrictive, illustrative embodiments of the present invention will be described in the following specification.

Fabrication of a ridge optical waveguide with a smooth surface and which is encapsulated within a medium having a refractive index lower than the material of the optical waveguide will be first described.

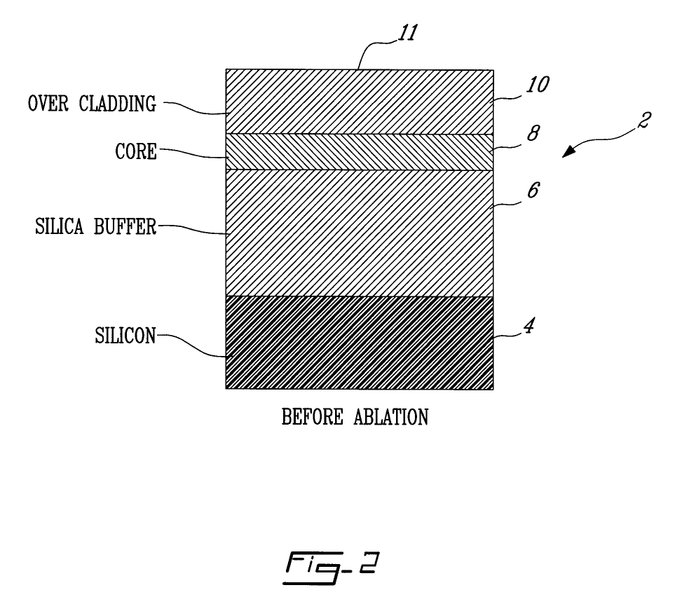

FIG. 2 is a cross-sectional view of a planar, multi-layer piece 2 of material that can be used to produce an optical ridge waveguide using, for example, a CO₂ laser beam. Although the preferred embodiments of the present invention will be described in relation to the use of a CO₂ laser beam, it is within the scope of the present invention to use any other suitable type of laser beam.

As illustrated in FIG. 2, the planar, multi-layer piece 2 of material comprises, in superposition, a substrate layer 4, a buffer layer 6 applied onto the substrate layer 4, a core layer 8 applied onto the buffer layer 6 and a cladding layer 10 applied onto the core layer 8.

The following table gives non-limitative examples for the refractive indices, thicknesses and materials of the four (4) layers 4, 6, 8 and 10 forming the planar, multi-layer piece 2.

| Layer | Refractive index | Thickness | | Material |
|---|---|---|---|---|
| Cladding layer 10 | 1.446 | 15 | microns | Boron phosphorus |
| | | | | silica glass (BPSG) |
| Core layer 8 | 1.456 | 7 | microns | Phosphorus or |
| | | | | germanium-doped |
| | | | | silica |
| Buffer layer 6 | Thermal oxide | 15 | microns | Silica |
| Substrate layer 4 | 3.4 | 0.6 | mm | Silicon |

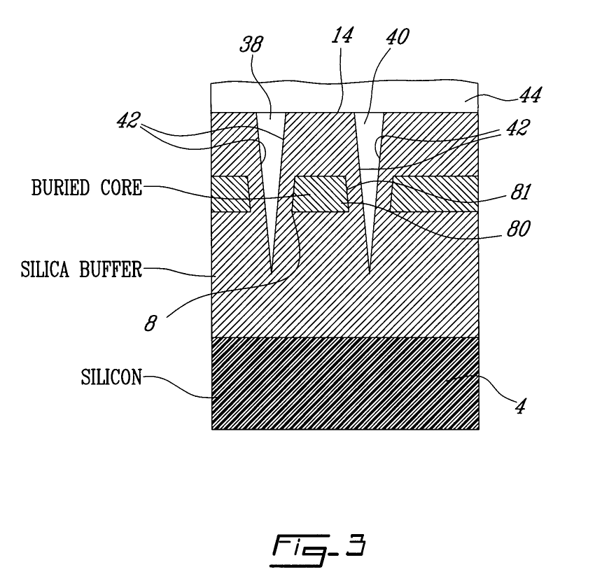

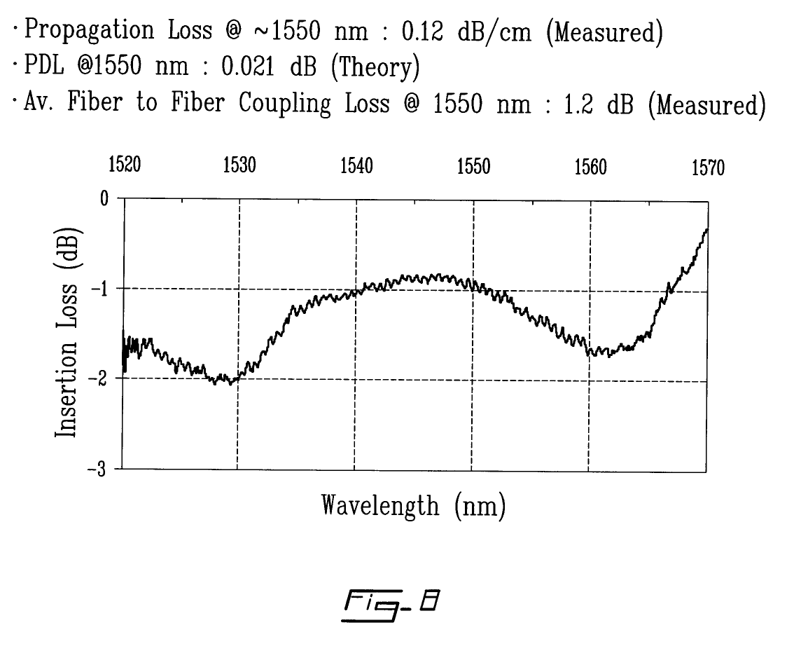

The buffer layer 6 and the cladding layer 10 both have a refractive index lower than a refractive index of the core layer 8, since the core layer 8 is destined to become an optical ridge waveguide once the planar, multi-layer piece 2 of material has been processed. More specifically, an ablation operation, which comprises cutting trenches 38 and 40 through the cladding 10, core 8 and buffer 6 layers using a CO₂ laser beam, is carried out to define a buried optical waveguide 80 that is completely encapsulated within the buffer 6 and cladding 10 layers as shown in FIG. 3. FIG. 10 illustrates that applying standard ablation to the same planar, multi-layer piece 2 of material does not produce in the core layer 8 an optical waveguide buried in the buffer 6 and cladding 10 layers; the core layer 8 is partly exposed to the air through the trenches 38 and 40.

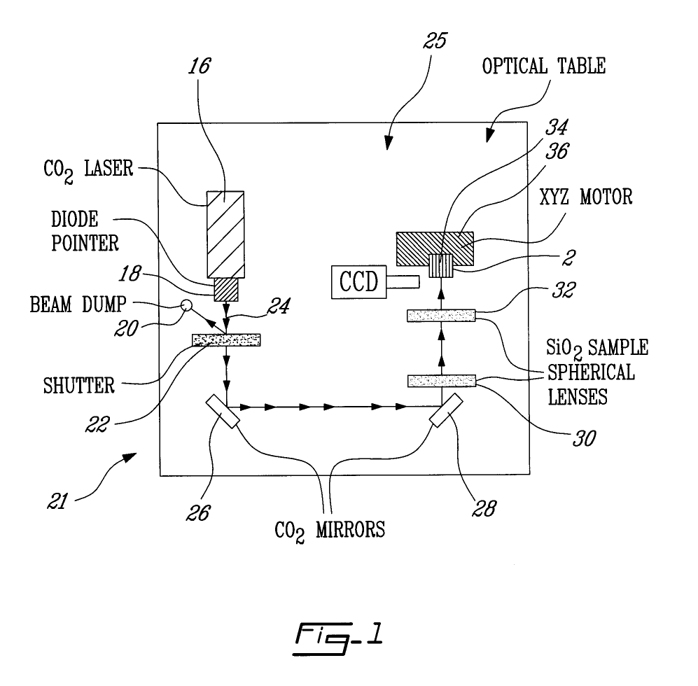

FIG. 1 describes a CO₂ laser assembly 21, mounted on an optical table 25 and used to ablate a planar, multi-layer piece of material such as 2 in FIG. 2. The CO₂ laser assembly 21 comprises a CO₂ laser generator 16 and a diode pointer 18 for generating a CO₂ laser beam 24 aimed toward a shutter 22 and, when the shutter 22 is closed, toward a beam dump 20.

The beam dump 20 may comprise an aluminum cone (not shown) with greater diameter than that of the CO₂ laser beam 24. The aluminum cone is anodized to a black color and enclosed within a canister (not shown) with a black, ribbed interior surface. When the shutter 22 is closed, only the smaller-diameter point of the cone is exposed to the CO₂ laser beam 24 and most of the incoming light grazes the inner surface of the cone at an angle. Any reflections from the black, anodized surface of the cone are then absorbed by the black, ribbed interior surface of the canister.

The function of the shutter 22 is to adjust the time over which the planar, multi-layer piece 2 of material is exposed to the CO₂ laser beam 24. More specifically, in the closed position, the shutter 22 will redirect the CO₂ laser beam 24 toward the beam dump. In the open position, the shutter 22 will allow transmission of the CO₂ laser beam 24 toward a mirror 26.

A series of two CO₂ laser beam mirrors 26 and 28, the normal of each being at 45° of the incident CO₂ laser beam 24, deviate the CO₂ laser beam 24 so that the resulting direction of the CO₂ laser beam is parallel but in opposite direction to the original direction of the CO₂ laser beam 24 from the shutter 22. Once the CO₂ laser beam 24 is deviated by the two mirrors 26 and 28, it passes through an optical system comprising a set of spherical lenses 30 and 32, so as to control minimum waste of the CO₂ laser beam 24. Finally the planar, multi-layer piece 2 of material is exposed to the CO₂ laser beam 24 stemming from the optical system (spherical lenses 30 and 32), the CO₂ laser beam 24 impacting the planar, multi-layer piece 2 of material substantially perpendicular thereto. The planar, multi-layer piece 2 of material is attached to a XYZ translation table 34. The XYZ translation table 34 is mounted to and moved about the optical table 25 through a XYZ translation motor 36. As can be appreciated, the XYZ translation motor 36 is connected to both and interposed between the XYZ translation table 34 and the optical table 25.

As a non-limitative example, the power of the CO₂ laser beam 24 applied to the planar, multi-layer piece 2 of material has a power of 1.65 Watts, with a wavelength of 10.6 μm and a diameter of 20 μm. Still in accordance with this non-limitative example, the speed of translation of the XYZ translation table 34 relative to the CO₂ laser beam 24 is 50 mm/s.

Advantageously, but not exclusively, the above parameters may be adjusted in the ranges as defined below:
CO₂ laser beam power: between 0.5 and 3 W;
CO₂ laser beam wavelength: 10.6 μm;
CO₂ laser beam diameter: between 11 and 60 μm; and
XYZ translation table 34 translating speed relative to the CO₂ laser beam: between 1 and 100 mm/s.

The process in accordance with one non-restrictive, illustrative embodiment of the present invention, for fabricating optical waveguides will now be described in connection with the accompanying figures.

In operation, the CO₂ laser beam 24 is applied onto the top exposed face 11 of the cladding layer 10 of FIG. 2. The power of the heating CO₂ laser beam 24 raises the temperature of the layers 6, 8 and 10 to about 1200° C. At this temperature, for example, Boron-doped silica or Germanium-doped silica begins to highly absorb the wavelength of the CO₂ laser beam 24. Initially, silica softens, then it quickly melts, and above a threshold that may be determined by incident power and exposure time, silica vaporizes thus resulting in an ablated trench. More specifically, phases of melting and ablation occur almost concurrently. Melting occurs in lower temperature material zones while ablation occurs in higher temperature material zones, leaving behind smooth trenches. As stated in the foregoing description, surface roughness of the walls of an optical waveguide determines the amount of light scattering and propagation loss in the waveguide. As can be seen in FIG. 3 which shows the planar, multi-layer piece 2 of material after it underwent the ablation operation, a portion such as 81 of the material of the buffer 6 and/or cladding 10 layers melting during ablation is not vaporized and leaks to encapsulate the region of the core layer 8 forming the buried optical waveguide 80, further protecting it and reducing propagation loss.

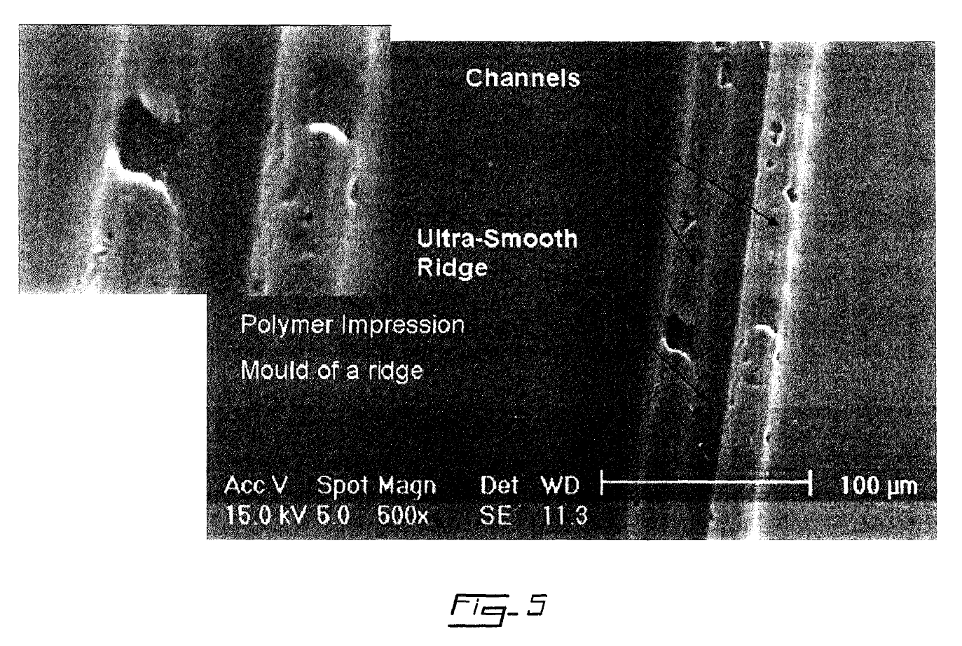

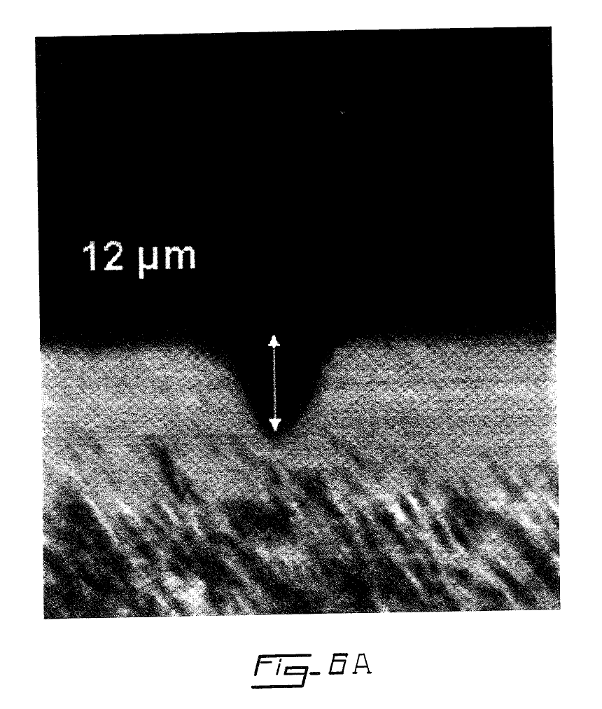

The above-described ablation operation on the planar, multi-layer piece 2 of material thus forms two trenches 38 and 40 (FIG. 3) because of material of the planar, multi-layer piece 2 that was ablated. The two trenches 38 and 40 define a ridge 14 there between, more specifically resulting in an optical waveguide having a very smooth ridge as shown in FIG. 5. The depth and width of the resulting trenches 38 and 40 are typically, but not exclusively, 20 microns and 12 microns, respectively, as shown in FIGS. 6a and 6b.

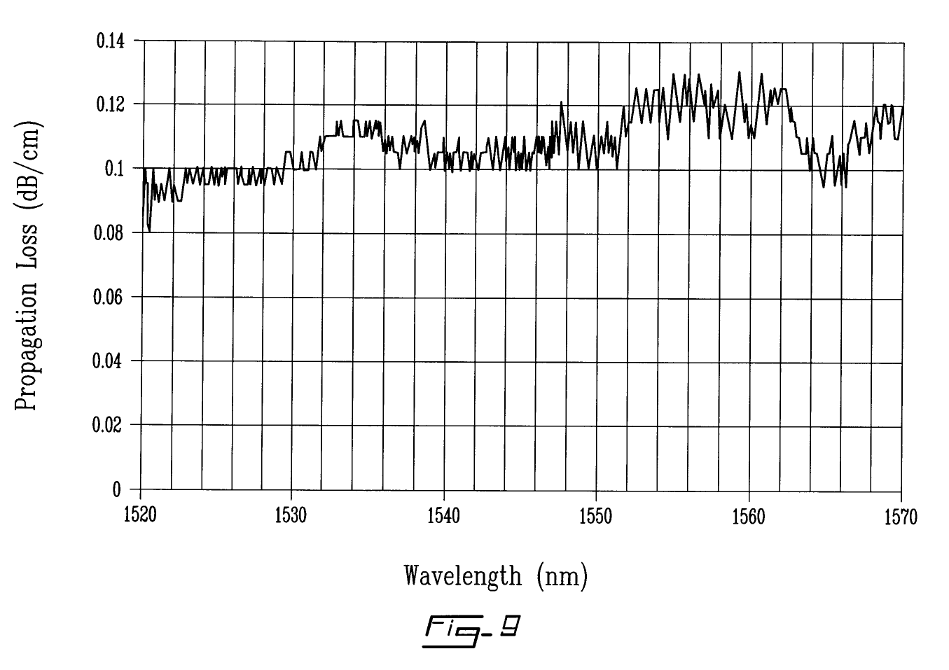

As already indicated, the trenches such as 38 and 40 are produced by ablation of material of the cladding 10, core 8 and buffer 6 layers by applying the CO₂ laser beam 24 onto the exposed face 11 of the cladding layer 10 in FIG. 2. Upon passage of the laser beam 24, most of the material ablated is vaporized. As the laser beam 24 moves away, the laser power level that is applied lowers and melted material from the cladding 10 and buffer 6 layers leaks alongside the walls 42 of the trench 38 or 40 to coat the core layer 8, as shown by reference 81 in FIG. 3. As a result, the portion of the core layer 8 between the two trenches 38 and 40 forms an optical ridge waveguide 80 totally encapsulated by a medium having a refractive index lower than that of the core layer 8. This presents the advantage of protecting the walls 42 of the trenches 38 and 40 from the surrounding environment while confining light into the core layer 8 of the ridge 14 forming the buried optical waveguide 80. The melting and mixing of silica, the out diffusion of germanium in the doped core layer 8 as well as stress-induced reduction of refractive index contribute to reduce the refractive index in the area immediately adjacent to the trenches 38 and 40, as will be described in more detail herein below. However, the silica cladding layer 10 is not significantly affected, as may be seen in FIG. 11.

The process of melting and ablation of the different layers of the planar, multi-layer piece 2 of material 2 is adjusted by controlling the laser flux, focus and rate of ablation so as to allow the top cladding layer 10 to be ablated followed by the ablation and melting of the core layer 8 as well as the intermixing of the melted silica cladding layer 10 with the melted germanium or phosphorus doped core layer 8. The melting temperature (and the ablation temperature) of the material of the doped core layer 8 is lower than that of the material of the silica cladding layer 10. This allows the phosphorus to out diffuse and the silica to partially indiffuse into the regions adjacent to the trenches 38 and 40. By so doing, the refractive index is reduced substantially in that region (such as 81 in FIG. 3). Therefore, the ablation process may be used to perform rapid thermal annealing of the affected zone, modifying the refractive index of, for example, the silica. By proper adjustment of the parameters of the ablation process, a guiding single mode region (such as 80 in FIG. 3) is maintained between the two trenches 38 and 40. The effect of the reduction of the refractive index in the lateral regions such as 81 is to bury the guiding region, creating a buried optical waveguide such as 80 in FIG. 3. A conventional, standard ablation process cannot produce a buried optical ridge waveguide having the above described characteristics, as clearly shown in FIG. 10.

As a last operation, a covering layer 44 as shown in FIG. 3 is applied onto the exposed face 11 (FIG. 2) of the cladding layer 10 for protection of the two trenches 38 and 40 or for other purposes. For example, the covering layer 44 can be used to prevent ablated material to redeposit on the cladding layer 10, or contamination of the walls of the trenches 38 and 40.

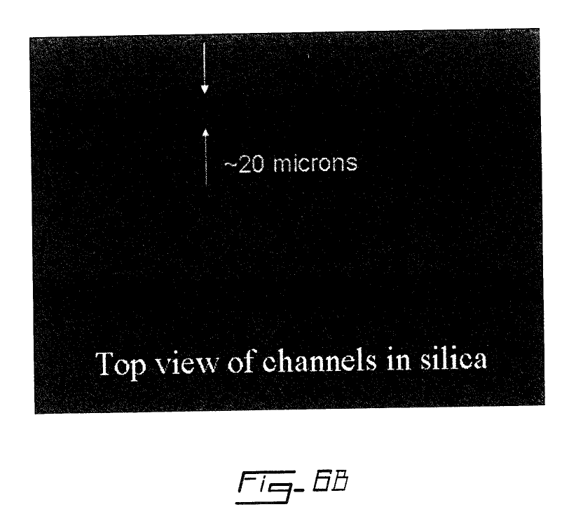

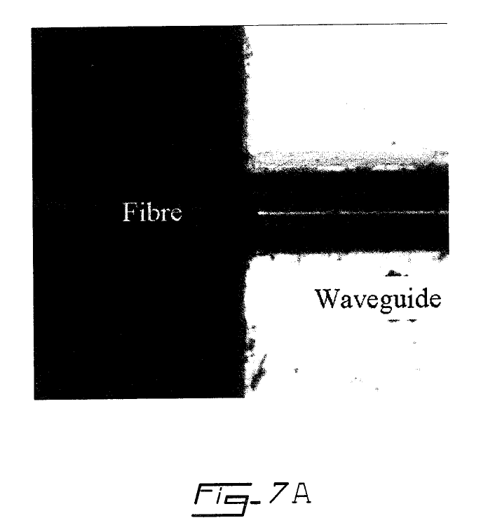

FIG. 7a shows a connection between an optical ridge waveguide obtained according to the non-restrictive, illustrative embodiments of the present invention and an optical fibre. FIG. 7b illustrates near field images of a guided mode in the waveguide of FIG. 7a. Experiments on the insertion loss of this type of connection have been performed and demonstrated advantageous results, as reported on the graph of FIG. 8.

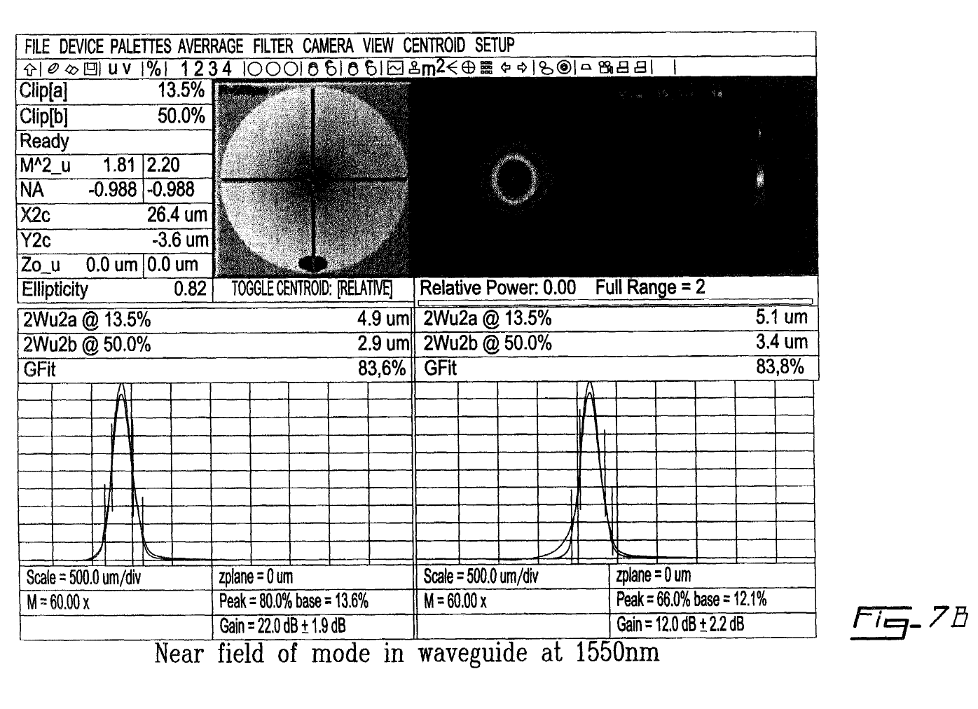

Other experiments, reported on the graph of FIG. 9, also show that propagation loss of the optical waveguide according to the non-restrictive, illustrative embodiments of the present invention is lower than the typical propagation loss of 0.1 dB/cm.

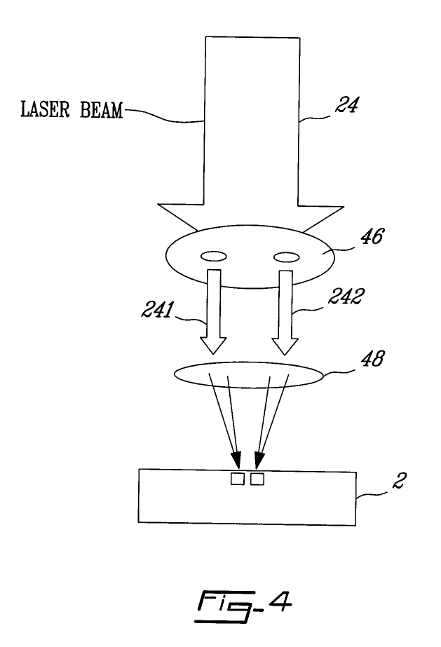

It is possible to accelerate the ablation operation by using a beam splitter, as shown in FIG. 4. According to FIG. 4, the CO₂ laser beam 24 may be separated by a beam splitter 46 for cutting the two trenches 38 and 40 simultaneously. More specifically, the CO₂ laser produces a beam 24 which is split through a beam splitter 46, so as to produce two parallel CO₂ laser beams 241 and 242 that are focused through a lens 48 onto the surface of the planar, multi-layer piece 2 of material. It is believed to be within the reach of a person skilled in the art to adequately select the beam splitter 46 and lens 48 so as to yield a desired distance between the two trenches 38 and 40.

Two pairs of CO₂ laser beams 241 and 242 can also alternatively be used to simultaneously cut the two trenches 38 and 40.

An application of the process of fabricating an optical waveguide according to the non-restrictive illustrative embodiment of the present invention can be found in the making of MMI (Multi-Mode Interference) structures. MMI structures are well known in photonics and they can be used to fabricate optical devices, for example but not exclusively beam splitters.

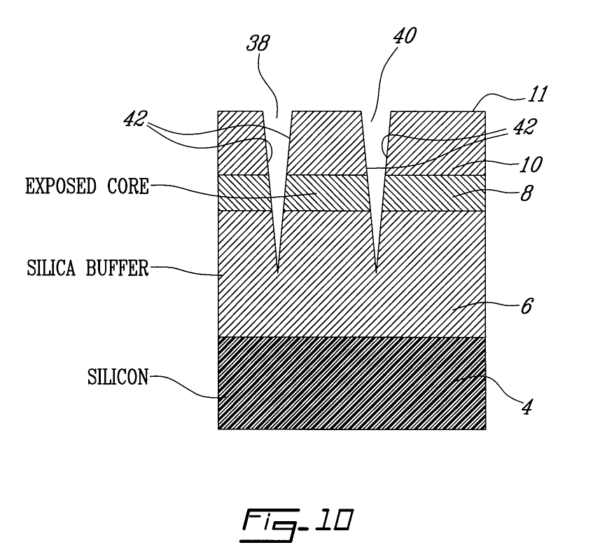

First, the basic principle of operation of MMI structures will be explained in relation to the structure 120 of FIG. 12.

An expanding light beam from an optical fibre 121 is folded by two mirrors, such as 122 and 123, separated by a distance d. As illustrated in FIG. 12, the two folded light beams propagate through a block of glass 124 and the two mirrors 122 and 123 are formed by surfaces of this block of glass 124. As the two folded beams propagate away from the source (optical fibre 121), they present expanding curved phase fronts that form interference patterns such as 125 at respective planes of interference normal to the direction of propagation of the folded light beams, indicated by the arrow 126.

By changing the aspect ratio of the structure 120 of FIG. 12, for example the ratio of the wavelength of the light beam from the optical fibre 121 to the thickness or other dimension of the block of glass 124, the number of interference nodes such as 127 at a plane of interference (not shown) can be altered from 1, 2, 3, 4, etc. For a fixed length structure, the interference pattern repeats at a repeat distance L along the direction of propagation 126 of FIG. 12. By appropriately choosing the geometry of the structure 120, the light beam from the source (optical fibre 121) can be divided into two or more bright spots located at respective planes of interference. If optical fibres are placed at these locations, the light beam from the optical fibre 121 can be split into a number of outputs with high efficiency.

It should be noted that, in the example of FIG. 12, since the block of glass 214 is a solid with infinite walls 123 and 124, the output will be under the form of light stripes perpendicular to the direction of propagation 121.

A similar technique can be used with a planar waveguide structure. In this case, the walls are no longer infinite in depth, but allow only a single mode to be propagated in a planar layer. If as above, light from a fibre source, such as an optical fibre, is to be launched into the planar layer, such as a planar film, walls are defined through the thickness of the planar film by some means such as photolithography and/or doping. At these boundaries, the light beam (now a mode) folds onto itself and interferes at certain planes (planes of interference) perpendicular to the direction of propagation to form higher order modes. Fibres placed at the right distances and locations allow the input single mode source to be split into many outputs.

Fabrication of such planar structures is generally a difficult task since it requires the normal process of mask making and processing. However, using the above-described process according to one non-restrictive, illustrative embodiment of the present invention, producing trenches upon fabricating optical waveguides greatly facilitates fabrication of optical devices using a MMI structure.

An advantage of using MMI structures to fabricate optical splitters resides in the fact that it is very simple to alter and fabricate MMI structures so as to obtain the required response characteristics of the optical splitters, as it is primarily a geometric problem. For example, a beam propagation method can be used to calculate and design optical devices, such as optical splitters, with the desired response.

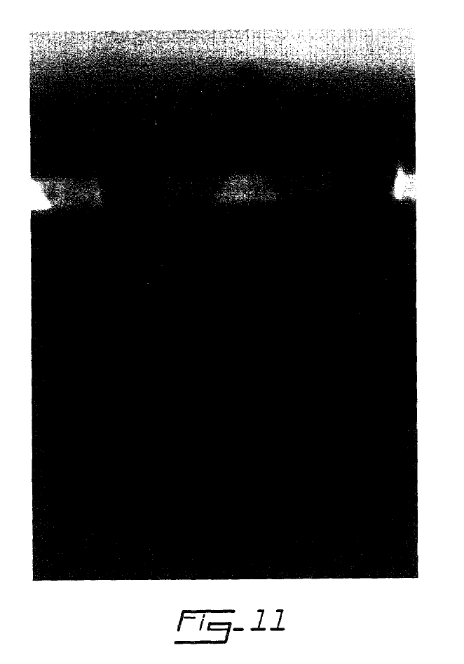

Referring to FIG. 13, a CO₂ laser beam such as 24 (FIG. 1), or any other suitable type of laser beam, can be used to design optical devices, such as beam splitters, in a planar sample of suitable material, such as the planar, multi-layer piece 2 of material of FIG. 2. More specifically, laser ablation using the CO₂ laser beam is used to form a MMI structure by delineating two walls of the MMI structure with an appropriate distance there between. For example, it is possible to simply make a chip with the correct dimensions to allow coupling of one or more input optical fibres or other optical waveguide to one or more output fibres or other optical waveguides.

As illustrated in FIG. 13, an input 130 of an optical device, such as a beam splitter, is shown as being an optical waveguide defined by two generally parallel, co-extending trenches 132 and 134. Another pair of generally parallel, co-extending trenches 136 and 138 forms the walls of a MMI structure. FIG. 13 further shows, for example, two output optical waveguides 140 and 142 defined by four generally parallel, co-extending trenches 144, 146, 148 and 150 at appropriate distances from each other and locations to create a 1×2 splitter, for example. Obviously, several of these devices may be cascaded to make an 1×n splitter, where n=4, 5, . . . , etc. The co-extending pairs of trenches 132, 134; 136, 138; 144, 146 and 148, 150 are made by laser ablation for example in a planar, multi-layer piece 2 of material as illustrated in FIG. 2 using, for example, the above-described process according to one non-restrictive, illustrative embodiment of the present invention capable of producing trenches upon fabricating optical waveguides. In this manner, the resulting waveguides, MMI structures and other waveguide structures are buried, that is encapsulated as described, for example in FIG. 3.

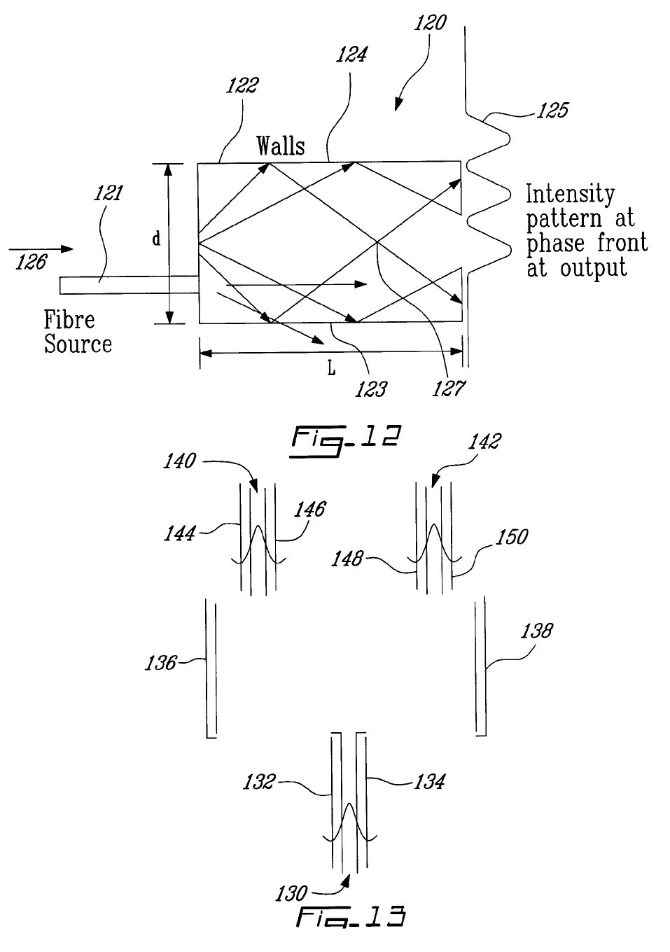

FIG. 14 illustrates a simulation of a 1×2 splitter according to FIG. 13, fabricated in a planar silica sample using the above-described laser ablation operation.

Still referring to FIG. 14, a planar waveguide layer is identified by the reference 200. The two vertical edges 202 and 204 are the etched (laser ablated) walls. Between the edges 202 and 204, the interference pattern is clearly visible as a function of propagation distance. It can be seen that the interference nodes such as 206 change in the direction of propagation from several nodes to two nodes for the illustrated 1×2 splitter.

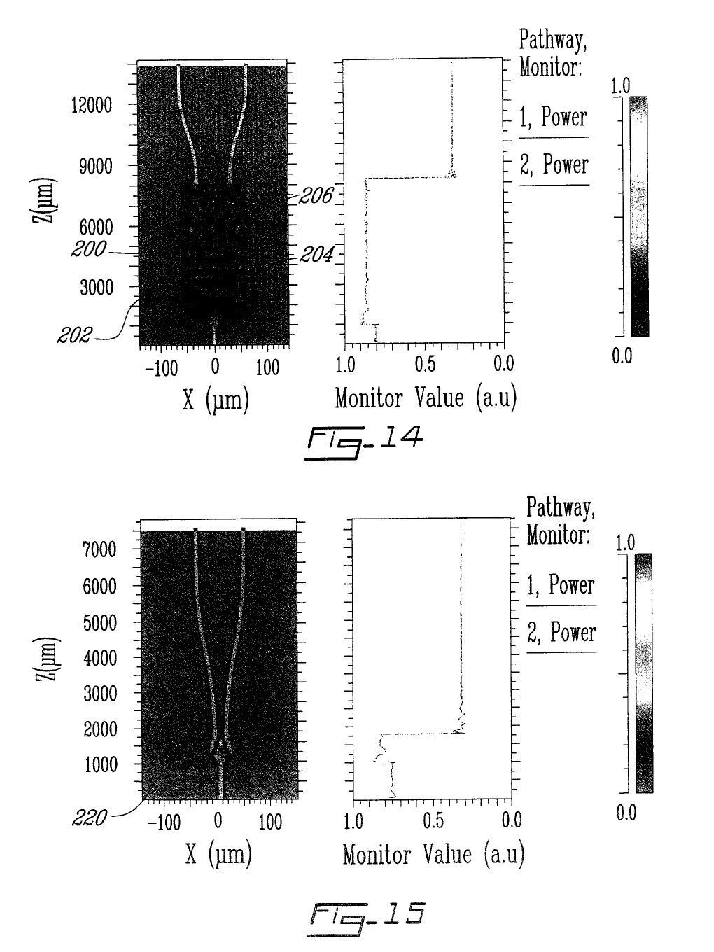

FIG. 15 illustrates a simulation of a compact 1×2 splitter in which only a small section of planar waveguide is needed.

Still referring to FIG. 15, the circled region 220 forms the MMI structure. The optical device of FIG. 15 is only 800 microns long and approximately 60 microns wide.

Again, it should be noted that most former laser ablation processes achieve very rough edges and consequently are useless in the fabrication of MMI optical structures. A very low insertion loss should be implemented in the fabrication of the MMI optical structures and for that purpose the walls of the ablated trenches should be as smooth as possible. By using the above-described process according to one non-restrictive, illustrative embodiment of the present invention for producing the trenches meets with these requirements upon fabricating MMI waveguides and optical devices for example as illustrated in FIGS. 13-15.

It should be pointed out that MMI structures can be used for making a number of optical devices other than beam splitters, for example but not exclusively arrayed waveguides and multiplexers, polarization splitters, inter-leavers, de-multiplexers, Mach-Zehnder interfeometers, etc.

In other embodiments of the above-described process according to one non-restrictive, illustrative embodiment of the present invention, the laser beam used for ablating trenches can be, for example but not exclusively, a frequency doubled laser beam, a quadrupled YAG laser beam or a laser beam that comprises a combination of any of the aforementioned laser beams, including a CO₂ laser beam.

Although the present invention has been described hereinabove by way of non restrictive, illustrative embodiments thereof, these embodiments can be modified at will, within the scope of the appended claims, without departing from the spirit and nature of the subject invention.

What is claimed is:

1. A process for fabricating a buried optical waveguide, comprising:
providing a multi-layer piece of material having a waveguide core layer;
generating a laser beam;
producing by ablation at least two trenches by applying the laser beam onto the multi-layer piece of material, the at least two trenches extending through the multi-layer piece of material including the core layer; and
upon the ablation, producing melted material from the multi-layer piece and encapsulating the core layer between the at least two trenches with the melted material to produce the buried optical waveguide in the multi-layer piece of material.

2. A process for fabricating a buried optical waveguide as defined in claim 1, wherein the multi-layer piece of material is a planar multi-layer piece of material.

3. A process for fabricating a buried optical waveguide as defined in claim 1, wherein the multi-layer piece of material further comprises a buffer layer and a cladding layer, and wherein the core layer is interposed between the buffer layer and cladding layer and the buffer layer and the cladding layer has a refractive index lower than a refractive index of the core layer.

4. A process for fabricating an optical waveguide as defined in claim 1, wherein generating the laser beam comprises generating a laser beam selected from the group consisting of a CO₂ laser beam, a frequency doubled laser beam, a quadrupled YAG laser beam, and combinations thereof.

5. A process for fabricating an optical waveguide as defined in claim 1, wherein:
generating the laser beam further comprises splitting the laser beam to produce at least two laser beams; and
producing by ablation at least two trenches comprises applying the at least two laser beams onto the multi-layer piece of material to simultaneously produce, by ablation, the at least two trenches in the multi-layer piece of material.

6. A process for fabricating a buried optical waveguide as defined in claim 1, wherein encapsulating the core layer comprises encapsulating the core layer within the buffer layer and the cladding layer.

7. A process for fabricating a buried optical waveguide as defined in claim 1, wherein encapsulating the core layer between the at least two trenches comprises encapsulating the core layer between the at least two trenches with material from the multi-layer piece having a refractive index lower than a refractive index of the core layer.

8. A process for fabricating a buried optical waveguide as defined in claim 1, wherein:
generating the laser beam comprises generating a laser beam having laser beam characterizing parameters; and
producing melted material from the multi-layer piece comprises adjusting the laser beam characterizing parameters to produce the melted material encapsulating the core layer between the at least two trenches.

9. A process for fabricating a buried optical waveguide as defined in claim 8, comprising selecting the laser beam characterizing parameters from the group consisting of a laser beam power, a laser beam wavelength, a laser beam diameter, a laser beam flux, a laser beam focus and an exposure time of the multi-layer piece of material to the laser beam.

10. A process for fabricating a buried optical waveguide as defined in claim 3, wherein producing by ablation the at least two trenches comprises cutting through the cladding layer, the core layer and the buffer layer using the laser beam.

11. A process for fabricating a buried optical waveguide as defined in claim 1, wherein producing by ablation at least two trenches comprises vaporizing of a portion of at least the core layer.

12. A process for fabricating a buried optical waveguide as defined in claim 1, wherein producing melted material from the multi-layer piece reduces a refractive index of said melted material subsequently encapsulating the core layer between the at least two trenches.

13. A process for fabricating a buried optical waveguide as defined in claim 3, further comprising applying a covering layer onto the cladding layer and the trenches when ablation has been completed.

14. A process for fabricating a buried optical waveguide as defined in claim 1, wherein producing by ablation at least two trenches by applying the laser beam onto the multi-layer piece of material comprises moving the laser beam relative to the multi-layer piece of material.

15. A process for fabricating a buried optical waveguide as defined in claim 14, wherein producing by ablation at least two trenches by applying the laser beam onto the multi-layer piece of material comprises directing the laser beam substantially perpendicular to a surface of the multi-layer piece of material.

16. A process for fabricating a buried optical waveguide as defined in claim wherein the buried optical waveguide is a ridge waveguide.

17. A process for fabricating a buried optical waveguide as defined in claim 4, wherein the buried optical waveguide comprises an MMI structure.

18. A buried optical waveguide comprising:
a multi-layer piece of material having a waveguide core layer;
at least two trenches laser ablated through the multi-layer piece of material including the core layer; and
encapsulating material having melted from the multi-layer piece upon laser ablation and leaked to cover and therefore encapsulate the core layer in the at least two trenches to thereby form the buried optical waveguide.

19. A buried optical waveguide as defined in claim 18, wherein the multi-layer piece of material is a planar multi-layer piece of material.

20. A buried optical waveguide as defined in claim 18, wherein the multi-layer piece of material further comprises a buffer layer and a cladding layer, and wherein the core layer is interposed between the buffer layer and cladding layer and the buffer layer and the cladding layer has a refractive index lower than a refractive index of the core layer.

21. A buried optical waveguide as defined in claim 20, wherein the core layer is encapsulated within the buffer layer and the cladding layer between the at least two trenches.

22. A buried optical waveguide as defined in claim 18, wherein the core layer between the at least two trenches is encapsulated between the at least two trenches with material from the multi-layer piece having a refractive index lower than a refractive index of the core layer.

23. A buried optical waveguide as defined in claim 20, wherein the at least two trenches extend through the cladding layer, the core layer and the buffer layer.

24. A buried optical waveguide as defined in claim 20, further comprising a covering layer applied to the cladding layer and the at least two trenches.

25. A buried optical waveguide as defined in claim 18, wherein the buried optical waveguide is a ridge waveguide.

26. A buried optical waveguide as defined in claim 18, comprising a MMI structure.

27. A buried optical waveguide as defined in claim 20, further comprising a substrate layer to which the buffer layer is applied.

28. A buried optical waveguide as defined in claim 26, wherein the MMI structure comprises a beam splitter.
